(19) United States
(12) Patent Application Publication
(10) Pub. No.: US 2003/0164042 A1
(43) Pub. Date: Sep. 4, 2003

(54) Electronic microcomponent, sensor and actuator incorporating same

(76) Inventor: Francois Valentin, Veurey-Voroize (FR)

Correspondence Address: Arthur L Plevy, Duane Morris, Suite 100, 100 College Road West, Princeton, NJ, 08540, US

(21) Appl. No.: 10/311,981

(22) PCT Filed: Jun. 28, 2001
(86) PCT No.: PCT/FR01/02075

(30) Foreign Application Priority Data
Jun. 29, 2000 (FR) 00/08420

(51) Int. Cl. G01P 15/125

(52) U.S. Cl. 73/514.32

(57) ABSTRACT

The invention concerns an electronic microcomponent, produced from a semiconductor substrate wafer (1), comprising two parts, namely a fixed part (10) and a mobile part (11) capable of mutual relative displacement. The invention is characterised in that each part comprises a plurality of plates (20, 21) perpendicular to the main surface of the wafer, the plates (20) of the mobile part (10) being interposed between the plates (21) of the fixed part (11); the plates (21) of the fixed part have an equipotential zone limited by a boundary substantially parallel to the main surface of the wafer (1); the plates (20) of the mobile part (10) have an equipotential zone which, in neutral position, partly covers and extends beyond the surface opposite the equipotential zone of the fixed part (11), such that a difference of potential applied between the equipotential zones of the plates (20, 21) of the fixed (11) and mobile (10′) parts, brings about variation in the surface opposite the equipotential zones, and the displacement of the plates (21) of the mobile part perpendicularly to the main surface of the wafer.

### TECHNICAL FIELD

The present invention relates to the field of microelectronics, and more specifically to mechanical microsystems. It more specifically relates to a microcomponent capable of a motion perpendicular to the plane of the-substrate in which it is formed. It finds an application in the manufacturing of actuators or of inertial sensors.

### PRIOR TECHNIQUES

It is already known to form sensors or micro-actuators by using the silicon semiconductor manufacturing technology. This type of sensors or micro-actuators, formed in a semiconductor wafer, comprises a part which is mobile with respect to the rest of the substrate, which is fixed.

The mobile part is connected to the rest of the substrate by areas of lesser thickness allowing some flexion and thus displacement of the mobile part with respect to the fixed part. When these devices are used as sensors, the accelerations undergone cause the displacement of the mobile part with respect to the fixed part. This displacement generates a variation in the facing surface area of the fixed and mobile parts. This variation thus translates as a variation in the electric capacitance measured between the fixed and mobile parts. The detection of this capacitance variation thus is an image of the undergone acceleration.

Conversely, when these devices are used as actuators, a potential difference is applied between the fixed and mobile parts. This potential difference causes an attraction or a repulsion of the mobile part with respect to the fixed part, and thus a motion of the mobile part.

Different architectures already have been envisaged to form such devices. Thus, U.S. Pat. No. 6,032,532 describes a sensor comprising two interdigited comb networks. These two networks thus form two capacitance plates, the facing surface area of which is maximized. Two of the combs are integer with the fixed part and interpenetrate two combs of the mobile part.

The mobile part has a degree of liberty in the substrate plane, and a voltage applied between the mobile part and the fixed part enables generating an electrostatic force proportional to the facing surface areas and to the square of the potential difference. These combs are obtained by surface or volume micromachining, followed by a release by dissolution of the underlayer of the mobile part.

The major disadvantage of such a system is that the mobile part can move only in the plane corresponding to the main wafer surface.

Further, the intensity of the stress exerted on the mobile part is limited by the relatively small thickness of the teeth of each comb, measured perpendicularly to the main wafer surface.

The progress of deep machining and substrate-on-insulator techniques has enabled improving such systems by creating large vertical walls with a small pitch, the release of which is obtained by dissolution of the insulating layer. This technique however always limits the direction of the motion to a plane parallel to that of the main wafer surface.

A problem that the present invention aims at solving is that of obtaining displacements of the mobile part in a direction perpendicular to the wafer plane, with a sufficient stress intensity, while using manufacturing techniques derived from known methods.

### SUMMARY OF THE INVENTION

The present invention thus relates to an electronic microcomponent, formed from semiconductor substrate wafers or the like, comprised of two parts, that is, a fixed part and a mobile part capable of moving with respect to each other.

This microcomponent is characterized in that:

each part comprises a plurality of plates perpendicular to the main wafer surface, the plates of the mobile part extending between the plates of the fixed part;

the plates of the fixed part exhibit an equipotential area limited by a border substantially parallel to the main wafer surface;

the plates of the mobile part exhibit an equipotential area which, at rest, partially covers and extends beyond the surface facing the equipotential area of the fixed part, so that a potential difference applied between the equipotential areas of the plates of the fixed and mobile parts causes the variation of the facing surface area of the equipotential areas, and the displacement of the plates of the mobile part perpendicularly to the main wafer surface.

In other words, each part comprises a set of vertical plates, arranged in the form of combs. The plates are typically formed by a lithographic method for the definition of their contour in the wafer plane, then by a deep selective etch operation enabling total anisotropic removal of the matter across the substrate thickness.

Because of their structure, the fixed and mobile plates have equipotential areas which partially face each other, and which are spatially shifted. Thereby, the application of a voltage between the two equipotential areas generates an electrostatic force which tends to bring the two plates nearer or push them away to maximize or minimize the surface area of the facing areas. Conversely, when the mobile part undergoes a motion, the equipotential area of the mobile plates moves with respect to the equipotential area of the fixed plates, and the electric capacitance measured between these two equipotential areas varies. In other words, the motion exerted perpendicularly to the wafer plane translates as the variation of an electric signal.

Thereby, a sensor responsive to an acceleration exhibit a component perpendicular to the wafer plane is formed. Conversely, an actuator according to the present invention enables moving an organ perpendicularly to the wafer plane.

Advantageously, in practice, the plates of the mobile part exhibit a height measured perpendicularly to the main wafer surface, which is lower than that of the plates of the fixed part.

In other words, when the plates of the mobile part or plate move vertically, they remain within the volume defined by the plates of the fixed part, without extending below the lower substrate surface.

The height difference between the plates of the mobile part or of the fixed part substantially corresponds to the maximum theoretical course of the mobile part with respect to the fixed part.

In a preferred form, the substrate used is laminated and comprises at least three layers, that is, two conductive layers separated by an insulating layer used as a border for the equipotential area of the plates of the fixed part. In other words, the definition of the equipotential areas is determined by the presence of the insulating layer of the laminated substrate. Generally, the substrate is a semiconductor substrate, but equivalent microcomponents may be obtained from substrates of different nature, and in particular those comprising ceramics.

Thus, at the level of the plates of the mobile part, at least two conductive layers may be electrically connected to form the equipotential area. Thereby, since the insulating layer of a laminated substrate is present on the plates of the fixed and mobile parts, it is possible to give the equipotential area of the mobile plates the desired geometry by interconnecting conductive areas in a configuration different from that of the fixed part. Thus, in the simplest geometry in which the semiconductor substrate comprises a single insulating area, the two conductive areas of the mobile plates are connected to form an equipotential area extending over the entire plate height. In this case, a single one of the conductive layers of the substrate will be chosen as an equipotential area on the fixed part.

As already mentioned, the microcomponent of the present invention may be used to form an inertial sensor (that is, a position or acceleration sensor) in which the position or acceleration information is an image of the variation of the electric capacitance measured between the equipotential areas of the fixed and/or mobile parts.

Such a microcomponent may also be used to form an actuator intended to move an organ which moves along with the mobile part, the assembly comprising means for applying a potential difference between the equipotential areas of the plates of the fixed and mobile parts. Thus, the equipotential areas of the fixed and mobile parts being vertically shifted, the application of the desired voltage causes a vertical motion, or more generally a motion perpendicular to the substrate plane.

In a specific form, the actuator may further comprise means for determining the relative position of the plates of the fixed and mobile parts, to control the means which apply the potential difference which generates the motion. In other words, such an actuator may operate with a closed-loop regulation, by measuring the variation of the capacitance between the plates, and thus controlling the potential difference to be applied to obtain the desired displacement.

### BRIEF DESCRIPTION OF THE DRAWINGS

The implementation of the present invention as well as the advantages resulting therefrom will appear from the description of the following embodiment, in conjunction with the appended drawings, among which:

FIG. 1 is a top view of an example of a microcomponent formed according to the present invention.

FIG. 2 is a partial cross-section view along plane II-II′ of FIG. 1.

FIG. 3 corresponds to the cross-section view of FIG. 2 in which the mobile part moves with respect to the fixed part.

FIG. 4 is a partial cross-section view along plane IV-IV′ of FIG. 1.

FIG. 5 corresponds to the cross-section view of FIG. 4 when the mobile part undergoes a motion with respect to the fixed part.

### IMPLEMENTATION OF THE PRESENT INVENTION

As already mentioned, the present invention relates to an electronic microcomponent formed from a semiconductor wafer 1. This type of wafer 1 is a laminated substrate, like for example the substrates known under abbreviation SOI, i.e. “silicon-on-insulator”.

As illustrated in FIG. 2, such a substrate 1 comprises two conductive layers 2, 4 of high thickness as compared to an intermediary insulating layer 3.

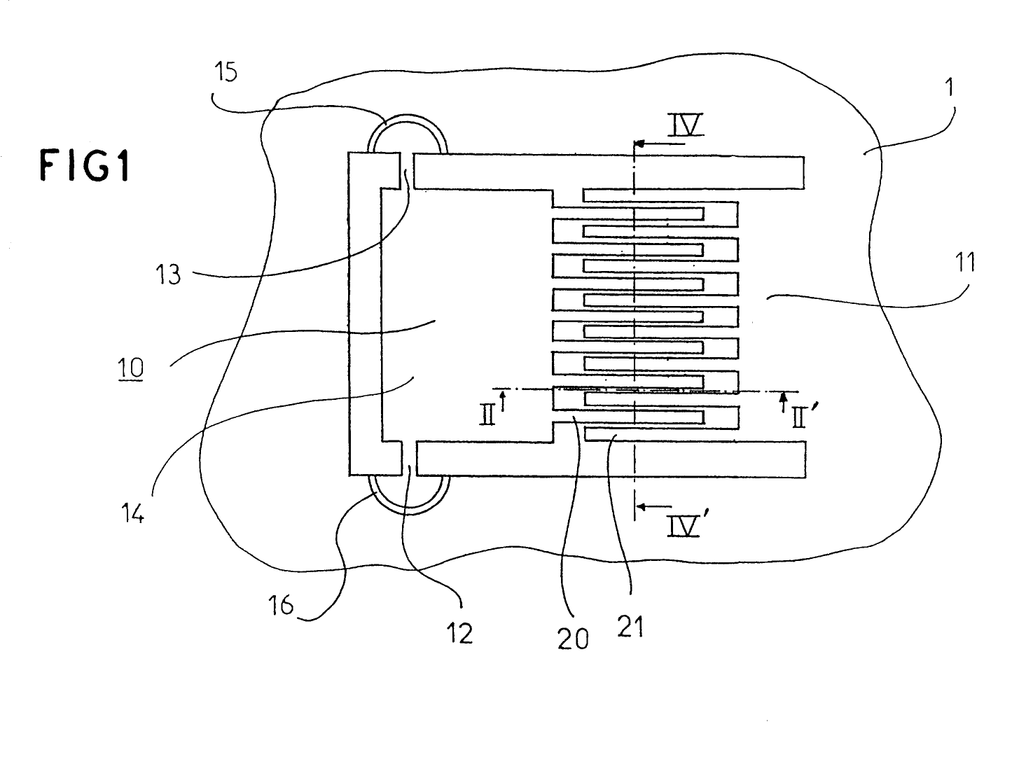

As illustrated in FIG. 1, such a microprocessor comprises a fixed part 11 and a mobile part 10. Fixed part 11 is integer with the rest of substrate 1. Mobile part 10 is connected to the rest of the substrate via two areas of lesser thickness 12, 13. The areas of lesser thickness 12, 13 have a flexion or distortion capacity which allow motion of the central area 14 of mobile part 10.

On one of its sides, central area 14 of fixed part 10 exhibits a set of parallel plates 20 perpendicular to the main surface 5 of the substrate. The number of plates 20 may be selected according to the desired application. Complementarily, fixed part 11 also comprises a plurality of plates 21 oriented towards mobile part 10, and which are oriented perpendicularly to the main surface plane 5 of the substrate.

Plates 21 of fixed part 11 partly penetrate into the space defined between each plate 20 of the mobile part. Plates 21 of the fixed part and plates 20 of the mobile part thus exhibit a relatively large facing surface area.

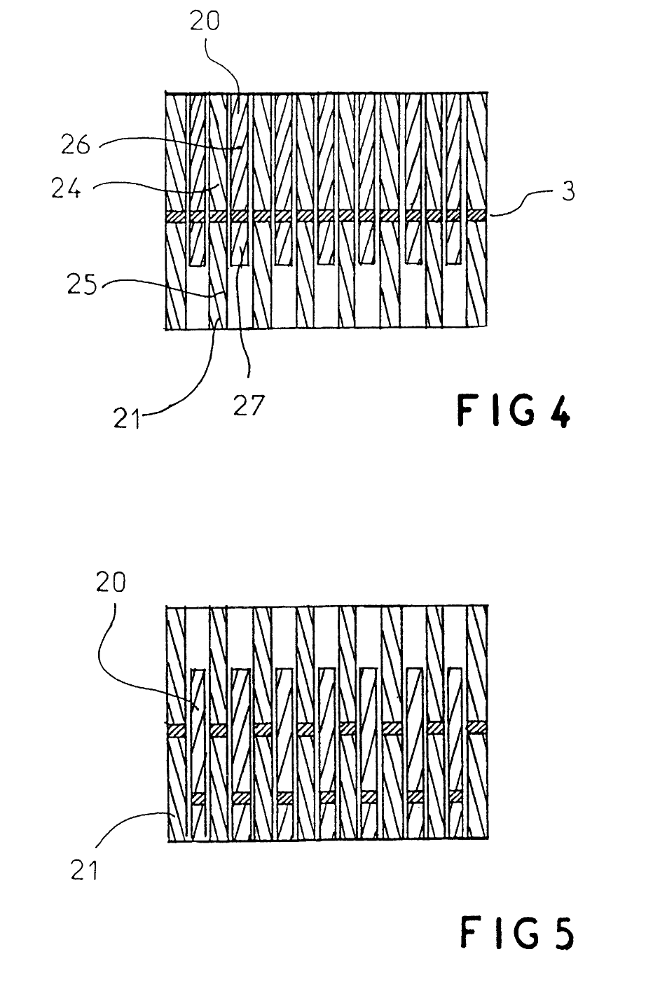

As can be seen in FIGS. 2 and 4, plates 21 of the fixed part extend over the entire substrate height. However, plates 20 of mobile part 10 exhibit a height, measured perpendicularly to plane 5 of the main substrate surface, which is smaller than that of plates 21 of the fixed part.

Further, insulating layer 3 of the substrate forms a border between the two conductive layers 2, 4 both on fixed plates 21 and on mobile plates 20. Thereby, areas 24 and 25 of plate 21 form electrically isolated equipotential areas. Conversely, according to the present invention on the fixed part, areas 26, 27 located on either side of insulating layer 3 are electrically connected. To electrically isolate fixed part 11 from mobile part 10, the electric continuity of conductive layers 2, 4 is broken. Thus, as an example and as illustrated in FIG. 1, an etch 15, 16 extending depthwise to reach insulating layer 3 and forming a routering around the flexion areas may be provided. Thereby, upper conductive layer 2 is interrupted between the fixed 11 and mobile 10 parts. The interruption of the lower layer may be obtained similarly or differently.

Thereby, areas 26, 27 of mobile plate 20 form a single equipotential area extending over the entire height of mobile plate 20. Because of the height difference of the mobile 20 and fixed 21 plates, the equipotential surface formed of areas 26, 27 of the fixed parts partially covers equipotential area 25 of fixed plate 21.

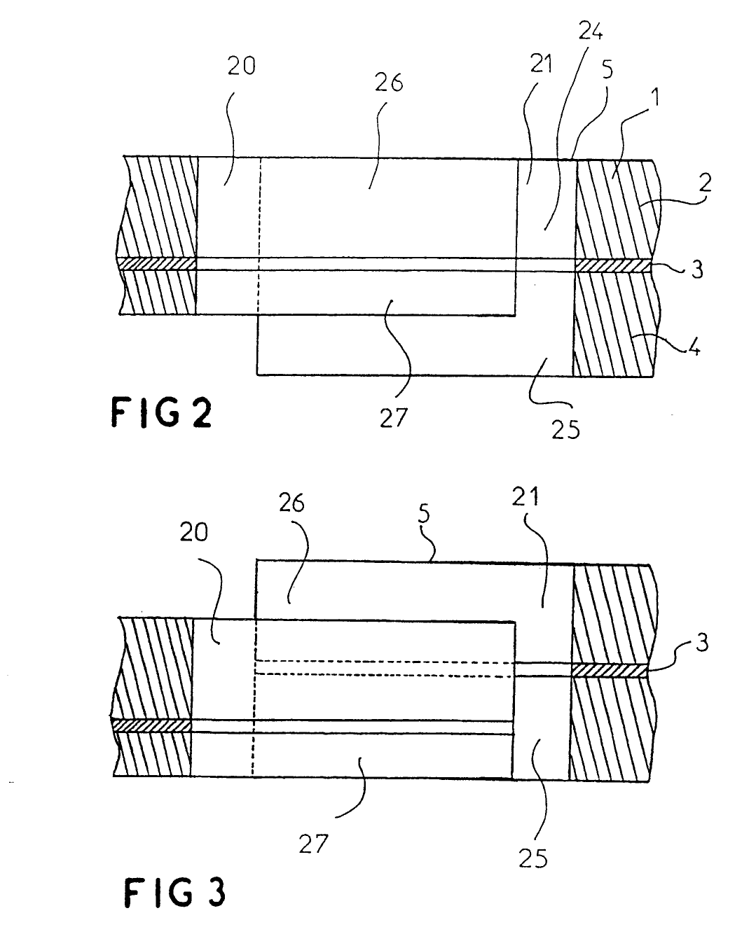

Thereby, equipotential surfaces 26, 27 and 25 of the fixed 21 and mobile 20 plates are the seat of electrostatic forces when a potential difference is applied thereto. Thus, when a potential difference is applied between the equipotential surfaces 26, 27 and 25, an electrostatic force tends to increase the facing surface area of these equipotential areas to bring the system to the configuration illustrated in FIG. 3. It can be observed that mobile plate 20 has undergone a motion perpendicular to the main surface 5 of the substrate. In practice, the vertical motion describes an arc of a circle, the radius of which depends on the geometry of the articulation area of mobile part 10 with respect to fixed part 11. This type of phenomenon corresponds to an actuator operation in which the motion of mobile part 10 with respect to fixed part 11 is controlled.

In the operation of the microcomponent as a sensor, the motion of mobile part 10, and thus of plates 20 with respect to fixed plates 21, induces a variation in the electric capacitance between equipotential area 26, 27 of mobile plate 20 and equipotential area 25 of fixed plate 21. The variation in this electric capacitance can be measured and provides an image of the amplitude of the motion of plate 20 with respect to plates 21, and thus of the acceleration of the undergone motion.

The actuator operation can be improved by means of a regulation which measures the amplitude of the generated motion by determining the electric capacitance variation between equipotential areas 26, 27 and 25. This capacitance measurement may be performed in a specific frequency range, distinct from the frequency of the voltage inducing the mechanical motion.

Of course, the present invention is not limited to the single geometric shape illustrated in FIGS. 1 to 5, but encompasses other alternatives in which the fixed part is not connected to the rest of the substrate by areas of lesser thickness, but has a sufficient length to be bent.

Similarly, the present invention is not limited to the use of a substrate having a single insulating layer, but encompasses alternatives in which the substrate has a plurality of insulating layers enabling definition of more than two conductive layers which are electrically interconnected to define partially overlapping equipotential areas shifted between the mobile plates and the fixed plates.

In practice, the microcomponent according to the present invention is obtained by deep machining techniques. Thus, in a first step, the contour of the mobile part and of the plate combs is defined on one surface or the other of the substrate. An anisotropic plasma etching is performed to define straight sides and walls as rectilinear as possible between the different fixed and mobile plates. Afterwards, an etch at the level of the lower surface of mobile plates 20 is performed to decrease their height, and thus create the spatial shifting between equipotential areas.

The foregoing shows that the microcomponent and its applications to actuators or sensors according to the present invention have multiple advantages, and especially that of enabling motion or detection along a plane perpendicular to the substrate plane.

The large surface area of the facing areas enables obtaining sufficient stress for the driving of a large type of organ. As an example, mobile micro-mirrors of large surface area, having a diameter of a few millimeters, which are used in optical switching applications, may be mentioned.

The present invention also finds a very specific application to the field of inertial sensors, while up to now, the forming of a tridirectional integrated sensor was only possible by the association of two bidirectional sensors. It is thus possible to form a tridirectional sensor on a single substrate.

1. An electronic microcomponent, formed from a semiconductor substrate wafer (1) comprising at least three layers, that is, first and second conductive layers (2, 4) separated by an insulating layer (3), this microcomponent being comprised of two parts, that is, a fixed part (10) and a mobile part (11) capable of moving with respect to each other, characterized in that:
each part comprises a plurality of plates (20, 21) perpendicular to the main wafer surface (5), the plates (20) of the mobile part (10) extending between the plates (21) of the fixed part (11);
the plates (21) of the fixed part (11) substantially extend across the substrate thickness, their portions (24) corresponding to the first conductive layer being at a same first voltage and their portions (25) corresponding to the second conductive layer being at a same second voltage;
the plates (20) of the mobile part (10) extend at least across the thickness of the first conductive layer and are all at a same voltage.

2. The microcomponent of claim 1, characterized in that the plates (20) of the mobile part extend across the thickness of the first conductive layer and across part of the thickness of the second conductive layer, the set of mobile plates being at a same voltage.

3. A position or acceleration sensor characterized in that it comprises the microcomponent of claim 1 or 2, and wherein the position or acceleration information is an image of the variation of the electric capacitance measured between the equipotential areas of the fixed and mobile parts.

4. An actuator intended to move an organ, characterized in that it comprises:
the microcomponent of claim 1 or 2 in which the organ moves along with the mobile part of the microcomponent;
means for applying a potential difference between the equipotential areas of the plates of the fixed and mobile parts.

5. The actuator of claim 4, characterized in that it further comprises means for determining the relative position of the plates of the fixed and mobile parts, to control the means for applying said potential difference.
